(19) United States
(12) Patent Application Publication
(10) Pub. No.: US 2018/0125211 A1
(43) Pub. Date: May 10, 2018

(54) SUPPORT OF SHOULDER HANDS-FREE FOR MOBILE DEVICES

(71) Applicant: Luis Omar Davila, Aguadulce (ES)

(72) Inventor: Luis Omar Davila, Aguadulce (ES)

(21) Appl. No.: 15/369,949

(22) Filed: Dec. 6, 2016

(30) Foreign Application Priority Data
Oct. 15, 2016 (ES) P201631333

(51) Int. Cl. A45F 5/00; F16M 13/04; H04B 1/3888

(52) U.S. Cl. CPC A45F 5/00; G03B 17/561; H04B 1/3888; F16M 13/04

(57) ABSTRACT

Hands-free support for mobile devices which includes a frame with two semicircular handles joined by a horizontal bar. In the center of the toolbar is located an elongated support at the end of which the mobile device that you want to use is fixed (smartphone, tablet, camera, video camera, etc.) to set what makes up the invention. This kit is put on the shoulders of the user, fixing it to the body in a stable manner of the user and, in this way, you can make use of the mobile device to a distance that allows its manipulation without having to hold it with your hands, this way enables you to perform several tasks at the same time and to set the extremities of the user free for this. Besides, due to its portability, it also allows the user to move freely, and it eliminates the fact of having to lean the mobile device to any surface outside the own body.

The following English translation of the specification is an accurate translation.

### TECHNICAL FIELD

The current invention refers in general to supports and methods of use for mobile devices. In particular, it refers to a set that consists of a rigid or semi-rigid frame formed by two semicircular handles which go from the back, passing through both shoulders and end up in the chest joined by an horizontal bar that is leaned on the chest, in which, at the same time, a device is located anchoring an elongated support where a mobile device is connected. The invention is put on the shoulders; in this way, the user has a firm and stabilized support where to place the mobile device, being able to perform a variety of tasks such as talking on the phone, watching videos, handling social networks, taking photos and videos, etc. All this, with a hands-free system which allows you to do so in motion. It is also interesting for being used by people with reduced mobility, for example, those ones who use crutches or wheelchairs.

### BACKGROUND OF THE INVENTION

With the spread of mobile devices (smartphones, digital cameras, tablets etc.) and its complexity, we have increased the time we are making use of these devices because every day we offer new possibilities and applications for this mobile devices, which often require us to hold them devices with our hands during a time more and more extensive every day. This can be tiring or impractical since it does not allow a simultaneous use of the device with another task, Nevertheless, with this device you would be able to watch videos or record them with your mobile phone at the same time that you could do perform other tasks. Besides, it would avoid our pulse to tremble in the case of taking a photograph, a selfie or video. So the result may be wholly unsatisfactory because we can be focusing incorrectly.

Until now, different apparatus have been used for facilitate the support of mobile devices; usually, a different one for each device. In the case of cameras, a traditional resource is the use of a tripod that can serve for this purpose. Example of this is the U.S. Pat. No. 6,254,044 of the United States; this is a suitable technique which sometimes is difficult and restricts us only to the use of photo or video cameras which need an external element to our body which should be positioned at a distance that does not allow optimal handling of the device.

Another example, also restricted to photographic devices, is the set with the telescopic arm of the camera Minolta Disc-7, which is sometimes sold as a kit. The kit includes a telescopic arm as an accessory. The tilting handle and the telescopic arm are shown in the U.S. Pat. No. 4,560,261 of the United States.

In the case of the rest of the mobile devices throughout these years, different fastening and support systems have been developed. Talking about phones, smartphones and other devices, some examples such as patents U.S. Pat. No. 8,162,283, U.S. Pat. No. 5,815,894, US20090218454, which make the user free to carry the device but, at the same time, which requires support in different surfaces (table, ground, etc.). In other cases, facilitating the handling with portable supports has become an option as they are expressed in patents US20120080462 and US20160134733, but which give little results at the time of leaving your hands free to do other different tasks simultaneously and, in the majority of cases, which cannot be used in motion as a limitation.

There are other systems that are used to carry the devices which let you to perform limited tasks such as recording videos and taking pictures. With the appearance of the go-pro camera, some accessories and types of harness that facilitate the motion recording have been popularized offering, in the majority of cases, the subjective perspective of the person who is recording, it is the case of the following patents: U.S. Pat. No. 6,955,484, U.S. Pat. No. 4,461,411, U.S. Pat. No. 8,342,758. Those can be adapted to different devices and to different parts of the body such as chest, wrist or head. Although they offer ease of use in motion, they have as the main problem the difficulty of taking self ies, talking on the phone or watching videos from digital devices among other disadvantages.

Finally, the stick of mobile devices also appears, patent No. US7,684,694, which liberates part of the management of the devices and enables improvements such as the movement and the fact of lacking a support surface at the time of performing self ies and other tasks with mobile devices. This is still very limited because it needs a hand to its management; therefore, it is not “hands-free” at all, and its use is limited only to recording or taking photographs, is not practical for the rest of the multiple uses of mobile devices.

### SUMMARY OF THE INVENTION

A goal of this invention is to provide a device through which the user of a mobile device (Smartphone, tablet, camera, video camera, etc.) can easily make use it without the need of holding it constantly with the hands or supporting it in another surface to perform different tasks, nor ensuring that they do not become tiresome or vague. Simply by placing the mobile device in the invention, it already wins autonomy and mobility.

More particularly, the object of the present invention provides a device that serves as a “hands-free” support for any mobile device, the invention that is inserted on the shoulders of the user holds the device to provide the freedom of hands movement. The appliance can also include a mechanism, which makes the elongated support that holds the mobile device can move in several positions. It is made of a frame with two handles that are put on both shoulders, a horizontal bar that connects the front ends of the lugs on the chest. In the center of the bar, a device is located where you anchor a lengthened support to put the mobile devices. This elongated support has the potential of being extensible and/or telescopic in order to adjust the distance from the base of the set to the mobile device that you want to use. This facilitates its management and offers the possibility to combine other activities not related to the management of the smartphone, tablet, camera, etc.

When putting the appliance on the shoulders, the user can also move comfortably carrying the appliance, manipulating it and making use of it without the need to involve the hands (hands-free function). For example, you can carry out a telephone conversation, watching or recording a video.

It is an additional feature that the device where you anchor the elongated support can be articulated and can adopt a 360 degrees turn. The elongated support can be extensible or telescopic and can adopt a 360 degrees turn also; therefore, the distance at which the device is anchored to the present invention can be regulated.

The utility of this appliance is also very remarkable in situations of reduced mobility. For example, in the case of people with crutches or in wheelchairs since it allows the simultaneous use of the present invention with the handling of the wheelchair or crutches. Due to the fact that the device is resting on the shoulders, it sets the rest of the body free.

### BRIEF DESCRIPTION OF THE DRAWINGS

The description is supplemented, for an easy understanding of the description that is being performed, with a set of drawings where, with an illustrative and non-restrictive feature, has been represented the following:

FIG. 1.—Displays the device and a mobile device, the term “mobile device” is used recursively in this request, so that “mobile device” refers to a video-phone, a mobile phone, smartphone, tablets, a film camera, a camera shots for a film camera, a video camera, and similar devices. A particular feature of this invention is that the appliance can be used to record auto-video and videos in general, to talk on the phone, watch videos and movies, navigate on the internet, meet social networks, etc. It also has other uses such as, for example, self-portraits and similar, photos with subjective perspective, photos of scenes, and photos in general. In reference to the FIG. 1, we can say that it illustrates the components of the invention which includes as its main components a set of base formed by a frame composed of two handles (1 and 2), which is supported and is fixed to the shoulders, these parts are joined among themselves by a horizontal bar or strap (with smooth form, tubular or other appropriate) (3), which is supported by the chest, in the center of the toolbar is located a device in which a lengthened support is anchored (4), perpendicular to the body, in which the mobile device is fixed (5) with a standard mobile support kit.

FIG. 2.—In the illustration shown in FIG. 2, its functionality appears demonstrated, and how the device is put in the body. The invention can be used in static as well as in motion, in a sitting position, lying and any other position in which the shoulders are aligned.

FIG. 3.—Shows a front view of the invention where you can observe the position of the horizontal bar with respect to the lugs of the shell.

FIG. 4.—Shows a top view of the invention and, in this way, you can see the distribution of the elements in the kit.

FIG. 5.—Shows a rear view of the invention and you can appreciate how the lugs are aligned in the part that is fixed at the back.

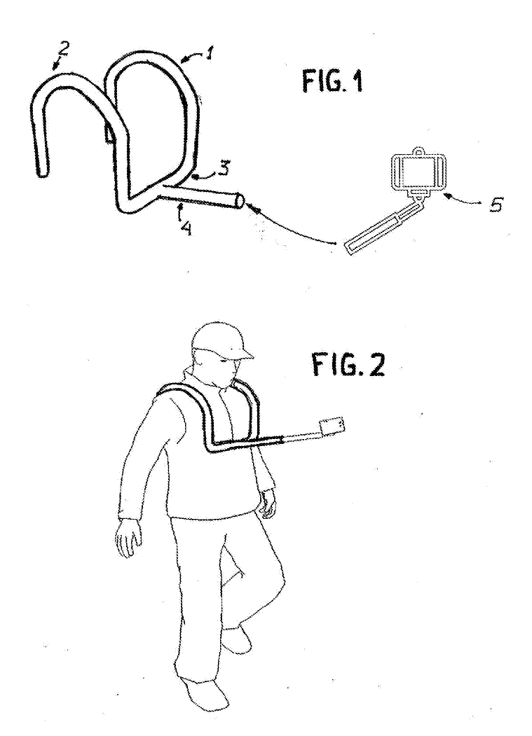

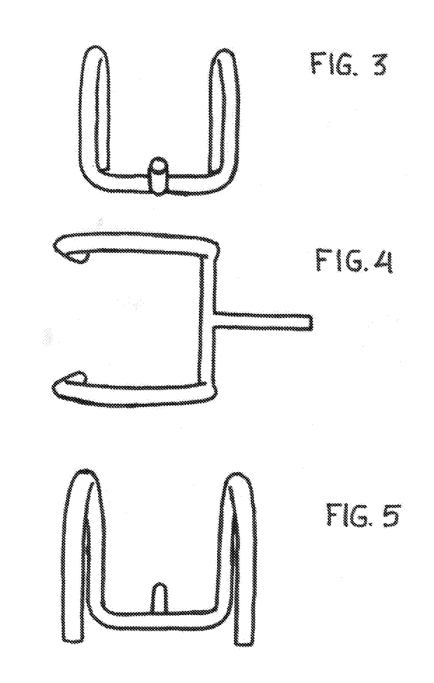

### PREFERRED IMPLEMENTATION OF THE INVENTION

The hands-free shoulder support for mobile devices consists of a base formed by a frame that can be semi-rigid or rigid composed of two tubular or semi-circular handles (1 and 2), which are supported and fixed to the shoulders. These parts are joined among themselves by an horizontal bar or strap (3), which is supported by the chest, in the center of this toolbar is located a device that can be articulated where a lengthened support is anchored (4) which is close in the end where the mobile device is supported, this can be tubular form (although it can have another shape, it also can be plain or have a telescopic format for a better mobility), perpendicular to the body, in which the mobile device is fixed (5) with a standard mobile support kit. The appliance, in general, can be made of plastic, aluminum, titanium, stainless steel or any other suitable material. In addition, it may be coated with rubber or any other suitable material to improve the grip and the user comfort. The mounting of the mobile device in the invention, FIG. 1, is done by adjusting the mobile device to the elongated anchor support (4) adjustment is performed by means of any standard support kit or any suitable clamping mechanism.

In the tubular form and/or telescopic elongated support (4) their caliber goes progressively decreasing toward the end where you assemble the mobile device, in addition to a plain tubular bar, you can use various telescopic bars. For example, they can be square, triangular, octagonal shape or any other, so that, it cannot rotate.

With regard to the industrial application, as it can be seen from the thins mentioned above, a person who uses the present invention is able to perform the following activities in a mobile device with hands-free function: watching videos and movies, managing their social networks, maintaining a telephone conversation, performing a video conference, recording or auto-recording on video, taking photos, auto-photos etc. All this both, statically or in motion; for example, in a meeting, doing sports, walking through the city, while teaching a class or a conference. It is light, practical, and the support on the shoulders ensures comfort and convenience. In addition, if the support is positioned on a surface or the ground can also make the function of tripod, it is particularly useful to follow, in a real form, the accurate indications of any appliance, device or application of geolocation, when being in motion.

The invention is targeted to the general public, but its essence role of hands-free makes it ideal for sportsmen, walkers, adventurers, lecturers, astronauts, university professors, people with reduced capabilities, communicators, people traveling with family or a large amount of luggage, etc. and any other person who needs to make use of a mobile device simultaneously with another manual task.

It is also best for manual accurate work that requires precise instructions; in this way, a person who is manipulating an appliance or mechanical system can perform the task while watching a video of instructions or following directions by means of a video conference, or displaying directly the evolution of his work.

It can be used very effectively in the kitchen where you can follow a recipe in video, or watch a TV show or a movie while you perform the tasks of the kitchen, without having to lean your mobile device in any surface and, therefore, with integrity having not been jeopardized. It is also very convenient for shooting the elaboration of a dish of kitchen and then being able to upload the video to the network.

1. The hands free shoulder support for the fixation of mobile devices (smartphone, camera, video camera, tablets, etc.) consists in a rigid or semi-rigid frame (or not) composed by two semicircular handles which go from the back, passing through both shoulders and end up in the chest, relying and fixing to the shoulders. These parts are joined among themselves by an horizontal bar or strap, which is supported by the chest. A device is located in the center of the toolbar where an elongated support is anchored of tubular or another suitable form. At the end of it, you can put a mobile device by means of with standard fixing means, being the role of the elongated support the fact of placing the mobile devices at an optimum distance of the body for its use simultaneously with other tasks which constitutes the hands-free function.

2. The semicircular lugs in accordance with the claim 1, are characterized because they can be semicircular or take another appropriate form to improve the ergonomics. In addition, it may have tubular, flat or another form, which may be appropriated and be carried out in rigid or semi-rigid material, and they can be foldable or not, and they can be adapted to the ergonomics of the shoulder, making of it the stabilization element of the support.

3. The horizontal bar or strap in accordance with the claim 1, is characterized because it may be made in a rigid or semi-rigid material (folding or not) and in the center of the same, a device is located which can be articulated or not, where a elongated support is anchored where the mobile device is put and it may be fixed or with adjustable movement.

4. The elongated support in accordance with the claim 1, is characterized being joined to the device attached to the horizontal bar permanently or removable, being able to be perpendicular to the body and narrowing their caliber toward the end where you put the mobile device.

5. The elongated support, where the mobile device is attached in accordance with the claim 1, is characterized being attached to the horizontal bar by means of a device with a tubular form or another suitable form, although it can also be placed on a turn round base of 360 degrees, ball device or another appropriate to facilitate the movement of the elongated support and, in this way, to regulate the location of your mobile device supported, both horizontally and vertically.

6. The elongated support in accordance with the claim 5 is characterized because it can be fixed and removable or mobile to allow both horizontal and vertical mobility.

7. The elongated support in accordance with the claim 1 is characterized because it can be done in a rigid or semi-rigid material, and at the end of it any mobile device is held through a standard media kit.
